(19) United States
(12) Patent Application Publication
(10) Pub. No.: US 2019/0226474 A1
(43) Pub. Date: Jul. 25, 2019

(54) PNEUMATIC PUMP

(71) Applicant: SOLIDSVAC PTY LTD, KRAMBACH (AU)

(72) Inventor: MARK DAMIEN KROHN, WOORIM (AU)

(21) Appl. No.: 16/375,021

(22) Filed: Apr. 4, 2019

Related U.S. Application Data
(63) Continuation-in-part of application No. 15/319,540, filed on Dec. 16, 2016.

(30) Foreign Application Priority Data
Apr. 16, 2014 (AU) 2014902302
Apr. 3, 2019 (AU) 2019901129

(51) Int. Cl. F04B 49/22; F04B 53/10; F16K 5/06

(52) U.S. Cl. CPC F04B 49/225; F16K 5/0647; F04B 53/1002

(57) ABSTRACT

A pneumatic pump is provided including a pressure vessel having a lower transfer port and an upper ventilation port; a transfer assembly communicating with said transfer port and including an inlet for pumpable material, and a delivery outlet, one or both of said inlet and said outlet having a valve facilitating selective flow therethrough; a venturi assembly having a suction side communicating with said ventilation port and a closable exhaust vent selectively operable to cycle said ventilation port between a suction phase and a pressurized phase; and a controller adapted to selectively close the exhaust vent. A rotatable valve apparatus is further provided. Also provide is a pneumatic pump fitted with a rotatable valve apparatus.

This invention relates to a pneumatic pump. This invention has particular application to a pneumatic pump for pumping flowable or semi-flowable waste compositions, chip-entraining spent drilling muds and the like, and for illustrative purposes the invention will be described with reference to this application. However, this invention may find use in other applications such as continuous-phase liquids, non-homogeneous particulate-solids-in-liquids compositions, and flowable particulate solids per se such as grain.

### BACKGROUND

The reference to any prior art in this specification is not, and should not be taken as, an acknowledgement or any form of suggestion that the referenced prior art forms part of the common general knowledge in Australia or elsewhere.

Pneumatic pumps may be used for pumping flowable compositions in hot or chemically and physically aggressive environments. The compositions may be intractable to rotary, piston and diaphragm pumps, or may be in or of environments where motive means such as internal combustion (IC) or electric motors cannot be used. The general configuration of a pneumatic pump comprises a pressure vessel cyclically transitioned between an intake cycle where compressed air is used to lower the internal pressure of the vessel by venturi effect to draw material in and a discharge cycle where the venturi is stalled or choked to pressurize the vessel and expel the material.

General principles of operation must be optimised for the pneumatic apparatus to be practical and/or efficient. Efficiency may demand that the delivery and/or inlet ports to the pressure vessel are controlled by gates. Control means may control timing of venturi cycle between vacuum and pressure phases, and control operation of any gate on the inlet and outlet. Control means may respond to time or charge mass to optimize cycle volumes. Efficient pumping of highly heterogenous material including a relatively large proportion of solids may be particularly challenging.

Conventional configurations of pressure vessels of pneumatic pumps usually include that the vessel is in the form of a solid of rotation to resist distortion under pressure, locates the material outlet at the lowest point to maximize gravity assistance, and spatially separates the inlet and the outlet. For example, the pressure vessel may comprise a vertical-axis vessel having a conical lower portion and a domed upper portion, wherein the inlet is toward the top of the vessel and the outlet is toward the bottom. In other embodiments a horizontal-axis vessel may comprise a dome-ended cylinder with the inlet and outlet separated both horizontally and vertically.

Existing designs may work well, at least for some applications, for large scale apparatus, but there can be difficulty associated with scaling down designs for portability. The shape of conventional designs may not admit of a compact package. The size of inlets and outlets (confined by the materials) may not scale down as far as the size of the pressure vessel by proportions, resulting in volumetric inefficiency.

Achieving efficient pumping of highly heterogenous material including abundant solids can be particularly challenging. The potential for blockage and/or infective closure of gates or valves that may be incorporated into inlet and/or outlet arrangements is a significant difficulty that can be encountered in the context of pumping highly heterogenous material using pneumatic pumps,

### SUMMARY

This invention in a first aspect resides broadly in a pneumatic pump including:

a pressure vessel having a lower transfer port and an upper ventilation port;

a transfer assembly communicating with said transfer port and including an inlet for pumpable material, and a delivery outlet, one or both of said inlet and said outlet having a valve facilitating selective flow therethrough;

a venturi assembly having a suction side communicating with said ventilation port and a closable exhaust vent selectively operable to cycle said ventilation port between a suction phase and a pressurized phase; and

a controller adapted to selectively close the exhaust vent.

Suitably, the venturi assembly of the pneumatic pump is a compressed gas-operated venturi assembly, Suitably, the venturi assembly is a compressed air-operated venturi assembly.

The pneumatic pump of the first aspect may suitably include a supporting frame, for supporting the pressure vessel. The supporting frame may take the form of a portable or transportable frame of metal or the like. The supporting frame may support all of the components of the apparatus as an assembly, whereby only fluid connections are required to put the assembly into service. The supporting frame may include roll-over or other in-service protection, such as roll-over bars, cage components or the like. The supporting frame may be provided with lifting points or adaptations for forklifting. The supporting frame for smaller installations may comprise a tubular steel frame, typically of all-welded construction.

The pressure vessel may be formed principally from any suitable material including but not limited to metal or reinforced polymer. The pressure vessel may be of any conventional shape. However, it has been determined that for smaller devices a spherically-derived shape can be desirable. Especially it has been empirically determined that the best compromise between useful volume, small overall size, and width to height ratio is provided by using a pressure vessel in the form of a disc, essentially a sphere flattened in the vertical plane to be taller and longer in the supporting frame than it is wide. Such a pressure vessel may have a narrow dimension selected to enhance access to relatively narrow industrial spaces.

The transfer port may penetrate the pressure vessel at any relatively lower position but is typically at or near a lowest point. The transfer port may penetrate the pressure vessel in any orientation. For example, a conical lower portion may advantageously include a transfer port oriented on the substantially vertical axis in the manner of a hopper chute. In the case of the spherical or disc-like pressure vessel the penetration of the transfer port may be either parallel to the disc axis (through the flattened side wall) or substantially perpendicular to the vertical plane containing disc axis (substantially tangential to the annular rim of the disc).

The transfer assembly may comprise a conduit extending from the transfer port. The conduit may include a T-connection with side branch connection substantially adjacent the transfer port and an axial connection adjacent the side branch connection. In an alternative, the conduit of the transfer assembly may comprise a Y-connection. In the case of a T-connection the side branch may comprise the inlet and the axial branch may comprise the outlet for the minor efficiency benefit conferred by this arrangement. The inlet and the outlet may be configured with quick-release coupling means such as cam-lock couplings.

Suitably, one or both of the inlet and outlet are fitted with a valve facilitating selective flow therethrough, with the choice determined at least in part by the application. The valve of the inlet and/or outlet may be a passive valve or an active valve.

In embodiments of the pneumatic pump wherein the valve of the inlet and/or outlet is a passive valve, the passive valve may be a non-return valve. The passive valve may be a swing valve. In some embodiments, the passive operation of the swing valve may be enhanced by a closure-assist mechanism. For example, the swing valve may be positively assisted and maintained in a closed position as part of a swing valve apparatus as hereinbelow described.

In some practical applications the inlet will be connected to a material source delivered by a head of pressure. In this instance the apparatus may be fitted with just an outlet passive valve, such as a non-return valve, to resist aspiration of contents from a delivery line downstream of the outlet on the vacuum phase of the venturi. In other applications the inlet may be fitted with a non-return valve to reduce the reflux of pressure vessel contents back up a supply conduit connected to the inlet during the pressure phase of the venturi. Efficiency may be optimized by fitting a non-return valve to both of the inlet and the outlet.

In the application of pumping non-homogeneous materials, passive valves, such as swing valves, may suffer from a statistical distribution of cycles where closure is incomplete. For said application, the use of an active valve or valves may be desirable. Alternatively, if a passive valve is to be used, a closure-assisted swing valve as present in a swing valve apparatus as herein described may be suitable.

In embodiments wherein a closure-assisted swing valve is present, the swing valve may be positively assisted and maintained in a closed position by a valve actuator. In embodiments, the valve actuator is a linear actuator. In embodiments, the valve actuator is of a swing valve apparatus, as hereinbelow described. Operation of the valve actuator may be controlled in concert with the closable exhaust vent of the pneumatic pump.

In embodiments of the pneumatic pump wherein the valve of the inlet and/or outlet is an active valve, suitably, the valve is actively convertible between an open configuration wherein flowable substance can pass therethrough, and a closed configuration wherein flowable substances is prevented or at least substantially constrained from passing therethrough.

Suitably, the valve is convertible between an open and a closed position using a valve actuator. In embodiments, the valve actuator is a rotary actuator. In embodiments, the actuator is of a rotatable valve apparatus, as hereinbelow described. Operation of the actuator may be controlled in concert with the closable exhaust vent of the pneumatic pump.

The active valve may be a rotatable valve, such as a quarter-turn valve. In embodiments, the rotatable valve is a ball valve. In typical embodiments, the ball valve is a two-way ball valve. In alternative embodiments, the active valve may be a knife gate valve.

Typically, in embodiments wherein the valve of the inlet and/or outlet is an active valve, the pneumatic pump comprises a first active valve fitted with, or incorporated as or as part of, the inlet, and a second active valve fitted with, or incorporated as or as part of, the outlet. In embodiments, the first and second active valves are operatively connected such that when the first active valve is in an open position the second active valve is in a closed position, and when the first active valve is in a closed position the second active valve is in an open position.

The venturi assembly of the pneumatic pump of this aspect may comprise an elongate venturi body comprising a venturi orifice interposed between the suction side communicating with said ventilation port and the closable exhaust vent. The closable exhaust suitably comprises a closure mechanism. The orifice may cooperate with a constant-flow gas, such as air, jet supplied by an external compressed gas, such as air, source to induce depression in the suction side of the body upstream of the jet. During the suction phase the open closure mechanism may allow the venturi exhaust to vent through a diffuser and/or muffler. Suitably, the diffuser and/or muffler constrains or prevents air screech, which may otherwise occur at relatively high decibels.

The closure mechanism of the closable exhaust vent may take any form consistent with allowing substantially open flow of venturi exhaust during the suction phase, and allowing sufficient occlusion of venturi exhaust during the pressurized phase. The closure mechanism may be selected from butterfly valves, gate valves, iris valves, slide valves and ball valves. The closure mechanism may be selected to provide an opening cross section substantially the same as or bigger than the cross section of the venturi orifice. The valve closure mechanism may be selected to have low inertia and/or be balanced to enhance speed of action.

The closure mechanism of the closable exhaust vent may be operated by a suitable closure actuator. A pneumatic closure actuator may be desirable given a suitable source of compressed gas, such as air, and the potential lack of useful electrical power in some operating environments. The closure actuator may comprise a rotary actuator or a linear actuator. The closure actuator may be a single-action actuator cycling against a return spring or may comprise a double-action actuator, typically depending on the operating parameters of the controller.

The controller of the pneumatic pump may comprise a digital-electronic over electric or pneumatic control mechanism, an analogue air over electric or pneumatic control mechanism. In order to provide for an air-only system, an air control over air deliver system may be used. For example, a combination of air solenoids and delay-dashpots may be used to provide for simple time-dependent cyclic control. Alternatively an air-analogue programmable logic controller may be used.

The energy of the venturi exhaust air may be used to optimise delivery line performance by being injected to the delivery line downstream of an outlet non-return valve. For example, the venturi exhaust air may be selectively passed through a two-way valve whereby one-way vents to atmosphere and the alternative way vents into the material outlet downstream of a non-return valve. The two-way valve may for example comprise a ball-tee valve. The two-way valve may be manual, remote-controlled, or demand operated by a condition-responsive mechanism.

While the working venturi is typically straight, the body upstream of the jet and orifice may be a curved conduit connected to the ventilation port, whereby the venturi and exhaust axis may be directed in a straight line toward the material outlet despite lack of clear line of sight between the ventilation port and the material outlet.

As described above, in some embodiments, the inlet and/or outlet of the pneumatic pump may be equipped with passive valves, such as swing valves, that are closure assisted, such as to alleviate tendency to fouling. In a second aspect there is provided a swing valve apparatus including:

a valve body having a swing chamber interposed between a valve inlet and a valve outlet;

an annular valve seat located in said swing chamber about an opening into said valve inlet;

a valve gate pivotally mounted in said chamber and adapted to move between a closed position substantially occluding said opening and an open position whereby fluid may pass from said valve inlet to said valve outlet; and

a valve closer mechanism operable to selective urge and maintain said valve gate in said closed position.

The valve gate may comprise a valve closure disc portion adapted to cooperate with the annular valve seat and a body portion pivoted to the walls of the chamber extension. The body portion may include a mechanism to assist with valve closer, associated with the chamber extension. For example, the body portion may include a surface that a selectively operated closer mechanism may cooperate with to effect closure and maintenance of the valve gate on the closed position.

In the case of the pumps described above, a valve gate assembly may comprise a supporting body pivoted to the walls of the chamber extension and having a front surface that mounts a resilient valve closure disc with, for example, a bolt and spreader washer. The front surface may lie in a plane that includes the pivotal axis of the valve gate. The supporting body may have a back surface adapted to cooperate with the valve closer means.

The valve closer mechanism may comprise a linear actuator that is adapted to utilize the transverse extension and is mounted to present a push rod adapted to pass closely adjacent the back or body portion surface. In order that there be provided an initial closing force the back or body portion surface may include a camming surface portion that the pushrod will first contact if the valve is not fully closed.

In one embodiment of the present invention the swing valve is for use on the inlet side of a pump in accordance with the present invention and may include a valve closer assembly including a double acting pneumatic linear actuator mounted coaxially with and closing the top end of a swing valve chamber extension. The actuator may include a push rod adapted to engage a body surface portion of a valve gate having a camming surface at the point of first contact of the push rod with the valve gate and closure maintenance portion engaged on substantially full closure.

As described above the inlet and/or outlet of the pneumatic pump may comprise an active valve, typically a rotatable valve, such as a ball valve. In a third aspect there is provided a rotatable valve apparatus including:

first and second valve bodies having respective rotation chambers interposed between respective valve body inlets and valve body outlets;

first and second rotatable valves located within the respective rotation chambers; and

a valve actuator connected with the first and second rotatable valves, wherein the valve actuator is convertible between;

a first configuration wherein the first rotatable valve is open and flowable substance can pass between the first valve body inlet and the first valve body outlet, and the second rotatable valve is closed and flowable substance is constrained or prevented from passing between the second valve body inlet and the second valve body outlet; and

a second configuration wherein the second rotatable valve is open and flowable substance can pass between the second valve body inlet and the second valve body outlet, and the first rotatable valve is closed and flowable substance is constrained or prevented from passing between the first valve body inlet and the first valve body outlet.

In embodiments, the rotatable valve apparatus comprises an intermediate body located between the first valve body and the second valve body. Suitably, the intermediate body is engaged with the first valve body outlet and the second valve body inlet. Suitably, when the valve actuator is in the first configuration, flowable substance can pass through the first valve body outlet to the intermediate body. Suitably, when the valve actuator is in the second configuration, flowable substance can pass from the intermediate body through the second valve body inlet.

Suitably, conversion of the valve actuator between the first configuration and the second configuration rotates the first and second rotatable valves between respective open and closed positions.

In embodiments, the valve actuator is a pneumatic actuator. In embodiments, the valve actuator of the rotatable valve apparatus is a rotatable actuator. The valve actuator may comprise a rotatable shaft, wherein the shaft is rotated during conversion of the actuator between the first configuration and the second configuration. Suitably, rotation of the rotatable shaft in a first direction towards the second configuration rotates the first rotatable valve from the open position towards the closed position and rotates the second rotatable valve from the closed position towards the open position; and rotation of the rotatable shaft in a second direction towards the first configuration rotates the first rotatable valve from the closed position towards the open position and the second rotatable valve from the open position towards the closed position.

In embodiments, the rotatable valve apparatus comprises a first arm connecting the rotatable shaft of the valve actuator with the first rotatable valve; and a second arm connecting the rotatable shaft of the valve actuator with the second rotatable valve. Suitably, rotation of the rotatable shaft of the valve apparatus rotates the first rotatable valve via the first arm and the second rotatable valve via the second arm.

The valve body or bodies of the swing valve apparatus of the second aspect or the rotatable valve apparatus of the third aspect may be substantially conventional for such valves and may be of bronze, stainless steel, reinforced polymer or other material. The valve inlet and valve outlet may be integrally formed with connector means including but not limited to male or female threaded portions, quick release connectors such as cam-locks, bayonet connections or the like.

In the case of swing valves of the second aspect, in the way of such valve bodies, there is generally provided a chamber extension or turret extending away from the flow axis and through which the valve gate may be pivotally installed the valve body. The chamber extension may include a bore that is substantially perpendicular to the flow path through the valve.

A fourth aspect of the invention provides the pneumatic pump of the first aspect fitted with the swing valve apparatus of the second aspect, or the rotatable valve apparatus of the third aspect.

One embodiment of the fourth aspect provides a pneumatic pump including:

a pressure vessel having a lower transfer port and an upper ventilation port;

a transfer assembly communicating with said transfer port and including an inlet for pumpable material, and a delivery outlet, the inlet incorporating a swing valve assembly facilitating selective flow therethrough;

a venturi assembly having a suction side communicating with said ventilation port and a closable exhaust vent selectively operable to cycle said ventilation port between a suction phase and a pressurized phase; and

a controller adapted to selectively close the exhaust vent,

wherein the swing valve assembly includes:

a valve body forming at least part of the pneumatic pump inlet, the valve body including a swing chamber interposed between a valve inlet and a valve outlet;

an annular valve seat located in said swing chamber about an opening into said valve inlet;

a valve gate pivotally mounted in said chamber and adapted to move between a closed position substantially occluding said opening and an open position whereby fluid may pass from said valve outlet inlet to said valve outlet; and

valve actuator operable to selective urge and maintain said valve gate in said closed position,

One embodiment of the fourth aspect provides a pneumatic pump including:

a pressure vessel having a lower transfer port and an upper ventilation port;

a transfer assembly communicating with said transfer port and including an inlet for pumpable material, and a delivery outlet, said inlet and outlet incorporating a rotatable valve assembly facilitating selective flow therethrough;

a venturi assembly having a suction side communicating with said ventilation port and a closable exhaust vent selectively operable to cycle said ventilation port between a suction phase and a pressurized phase; and

a controller adapted to selectively close the exhaust vent,

wherein the rotatable valve assembly includes:

a first valve body forming at least part of the pneumatic pump inlet and a second valve body forming at least part of the pneumatic pump outlet, the first and second valve bodies having respective rotation chambers interposed between respective valve inlets and valve outlets;

first and second rotatable valves located within the respective rotation chambers; and

a valve actuator connected with the first and second rotatable valves, wherein the valve actuator is configurable between:

a first configuration wherein the first rotatable valve is open and flowable substance can pass between the first valve inlet and the first valve outlet, and the second rotatable valve is closed and flowable substance is constrained or prevented from passing between the second valve inlet and the second valve outlet; and

a second configuration wherein the second rotatable valve is open and flowable substance can pass between the second valve inlet and the second valve outlet, and the first rotatable valve is closed and flowable substance is constrained or prevented from passing between the first valve inlet and the first valve outlet.

In the preceding embodiments of the fourth aspect, the controller adapted to selectively close the exhaust vent of the venturi of the pneumatic pump may further be adapted to operate the valve actuator.

### BRIEF DESCRIPTION OF THE DRAWINGS

The invention will be described with reference to the following non-limiting embodiment as illustrated in the drawings and wherein:

FIG. 1 is a front view of an embodiment of a pneumatic pump apparatus, pneumatic pump 10A, in accordance with the present invention. Pneumatic pump 10A is fitted with a swing valve apparatus, swing valve apparatus 50.

FIG. 2 is a sectional side view of the apparatus of FIG. 1.

FIG. 3 is a diagram of air, fluid and control flows of the apparatus of FIG. 1.

FIG. 4 is a sectional view of a swing valve apparatus 50.

FIG. 5 is a perspective view of the apparatus of FIG. 1.

FIG. 6 is a cover for the apparatus of FIG. 1.

FIG. 7 is a perspective view of an embodiment of a pneumatic pump apparatus, pneumatic pump 10B, in accordance with the present invention. Pneumatic pump 10B is fitted with a rotatable valve apparatus, rotatable valve apparatus 100, as herein described.

FIG. 8 is perspective view of a ball valve component of an embodiment of rotatable valve apparatus 100.

FIG. 9 is a top perspective view of components connecting a rotatable shaft with rotatable valves of an embodiment of rotatable valve apparatus 100.

FIG. 10 is manufacturer information for a suitable ball valve component for use in embodiments of rotatable valve apparatus 100. Numbering used in FIG. 10 makes internal reference to the part numbering table provided in the figure.

FIG. 11 is manufacturer information for a suitable pneumatic actuator for use in embodiments of rotatable valve apparatus 100. Numbering used in FIG. 11 makes internal reference to the part numbering table provided in the figure.

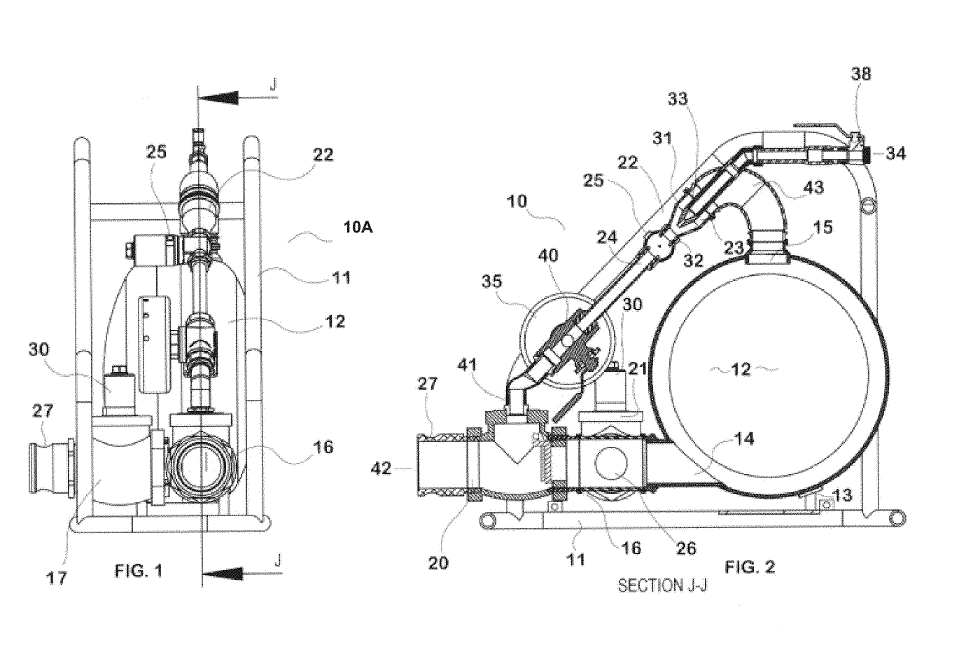

### DESCRIPTION OF EMBODIMENTS

In the figures there is illustrated pneumatic pump 10A and 10B. Reference will primarily be made to figures depicting the 10A embodiment. However, it will be understood that the 10B embodiment includes the same or similar components, unless otherwise indicated.

Pneumatic pumps 10A and 10B comprise a supporting steel frame 11; and a steel, disc-shaped pressure vessel 12 supported on the frame at anchor points 13. Steel frame 11 of pneumatic pump 10A is a tubular steel frame. Steel frame 11 of pneumatic pump 10B is a wheel-mounted steel frame.

Steel pressure vessel 12 of pneumatic pumps 10A and 10B includes lower, tangential transfer port 14; and upper, radial ventilation port 15.

Transfer assembly 16 communicates with transfer port 14 and includes inlet assembly 17 for pumpable material; and delivery outlet assembly 20.

Ventilation port 15 mounts compressed air-operated venturi assembly 22 having suction side 23 communicating with ventilation port 15 and exhaust vent 24 including closure assembly 25 selectively operable to cycle ventilation port 15 between a suction phase and a pressurized phase.

Inlet assembly 17 and outlet assembly 20 of pneumatic pump 10A comprise respective swing valve apparatus 50 mounted on adjacent branches of T-connector 26 connected to transfer port 14.

Inlet assembly 17; outlet assembly 20; and T-connector 26 of pneumatic pump 10B incorporate rotatable valve apparatus 100.

Each of inlet assembly 17 and outlet assembly 20 is provided terminal camlock connector 27.

Venturi assembly 22 comprises elongate venturi body 31 including venturi orifice 32 interposed between suction side 23 communicating with ventilation port 15 and exhaust vent 24. Orifice 32 cooperates with constant-flow air jet 33 supplied by external compressed air source 34 to induce depression in suction side 23 of body 31 upstream of the jet 33. During the suction phase open closure assembly 25 allows the venturi exhaust to vent through diffuser/muffler 35 to reduce high-decibel (dB) air screech.

Closure assembly 25 comprises low-inertia, lubricationless ball valve 36 operated by single action, spring return pneumatic actuator 37. Air source 34 may be shut off by stop cock 38, providing a master on-off switch for the apparatus.

Diffuser/muffler 35 is mounted on a side branch of manual two-way T-valve 40.

In pneumatic pump 10A, the straight-through path of T-valve 40 is in fluid communication with modified top cap 41 on outlet 20, thereby allowing venturi exhaust air to pass selectively into either diffuser/muffler 35 or delivery line 42 downstream of the swing valve of swing valve apparatus 50 of outlet assembly 20.

In pneumatic pump 10B, the straight-through path of T-valve 40 is in fluid communication with a delivery line connector of outlet 20 upstream of camlock connector 27.

In order to maintain a straight venturi exhaust flow path, venturi body 31 upstream of the jet 33 and orifice 32 may be a curved conduit 43 connected to the ventilation port 15.

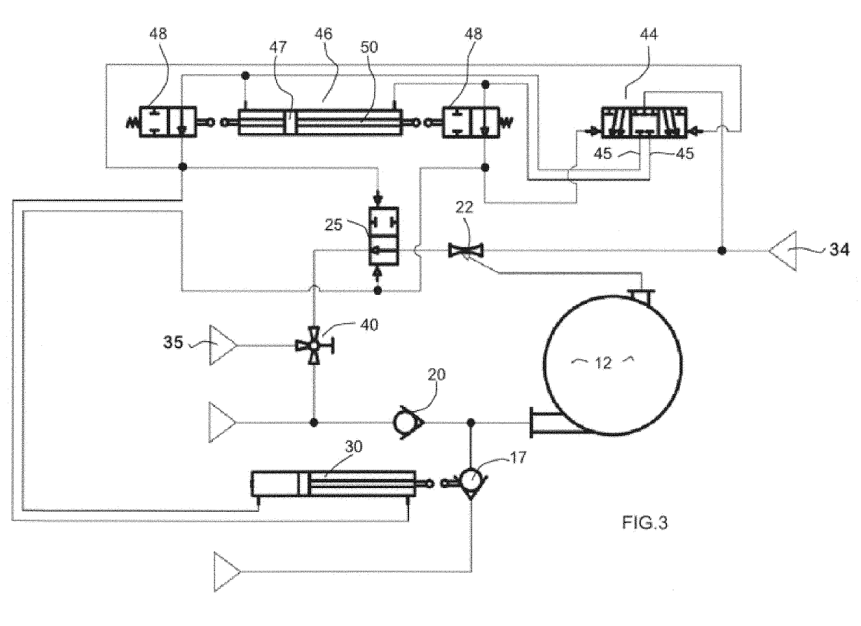

In FIG. 3 is illustrated an embodiment of a control arrangement suitable for control of pneumatic pump 10A/10B, wherein compressed air source 34 supplies (at supply pressure) both venturi assembly 22 and double switching (push-pull) primary air solenoid 44. The air distributed by two outlets 45 of solenoid 44 pass to respective ends of double acting pneumatic dashpot 46 which acts as a timer element. Piston 47 of the dashpot 46 mounts double ended rod 49 which, at the respective ends of travel triggers respective air switches 48 providing feedback control to solenoid 44.

Venturi assembly 22 depressurises pressure vessel 12 when closure assembly 25 is open, whereupon exhaust air may pass, depending on the setting of manual T-valve 40 to diffuser/muffler 35 or into the delivery line at or downstream outlet assembly 20.

The timer element of the control arrangement push-pulls closure assembly 25 to timer-operate the cycling of venturi assembly 22 between the suction and pressurization phases.

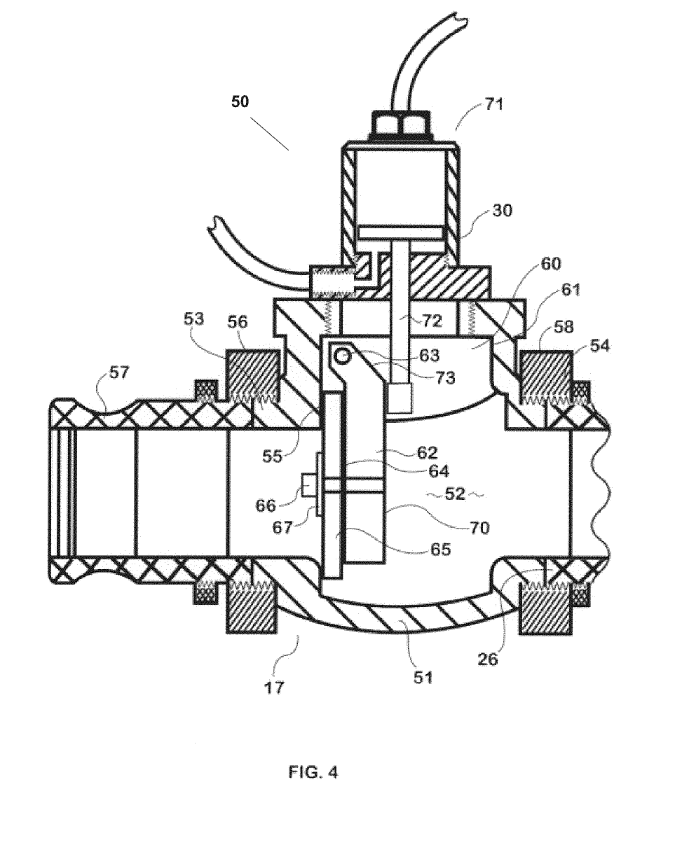

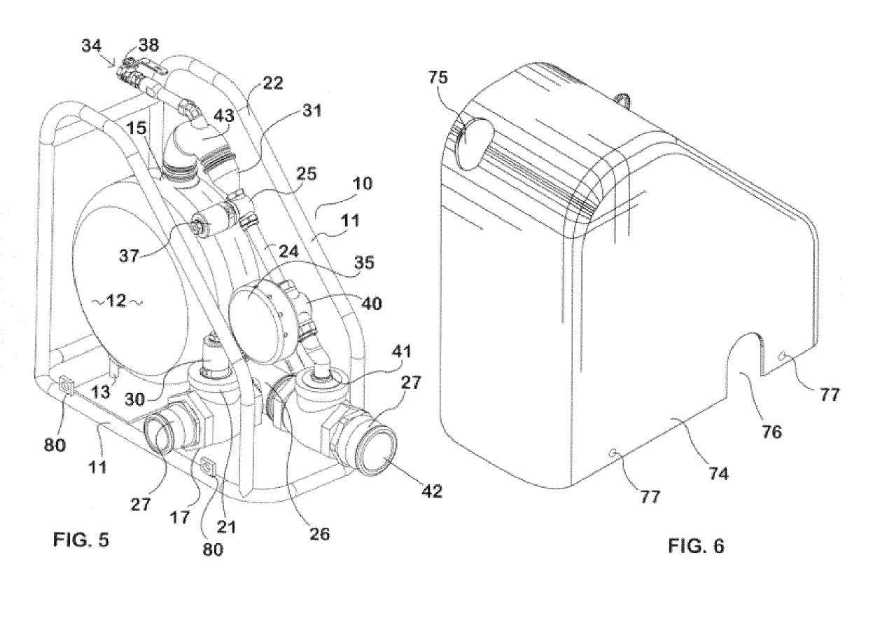

In FIG. 4 is depicted swing valve apparatus 50, incorporated into inlet assembly 17 of pneumatic pump 10A. Swing valve apparatus 50 includes cast stainless steel valve body 51 having swing chamber 52 interposed between valve inlet end 53 and valve outlet end 54. Annular, integral valve seat 55 is formed in swing chamber 52 about an opening into inlet end 53. Valve inlet end 53 mounts threaded collar 56 supporting cam-lock male spigot 57. Valve outlet end 54 mounts threaded collar 58 supporting a threaded side branch of the T-connector 26 of inlet assembly 17,

Chamber extension 60 of swing valve apparatus 50 includes bore 61 that is substantially perpendicular to the flow path through the valve.

A valve gate assembly of swing valve apparatus 50 comprises stainless steel supporting body 62 pivoted at 63 to the walls of the chamber extension 60 and has front surface 64 that mounts resilient polyurethane valve closure disc 65 with bolt 66 and spreader washer 67. Front surface 64 lies in a plane that includes the pivotal axis of the valve gate. Supporting body 62 has back surface 70 adapted to cooperate with valve closer means 71 comprising double acting, linear actuator dashpot actuator 30 screw-mounted to chamber extension 60 to present push rod 72 adapted to pass closely adjacent back surface 70. Back surface 70 includes camming surface portion 73 that pushrod 72 will first contact if the valve is not fully closed.

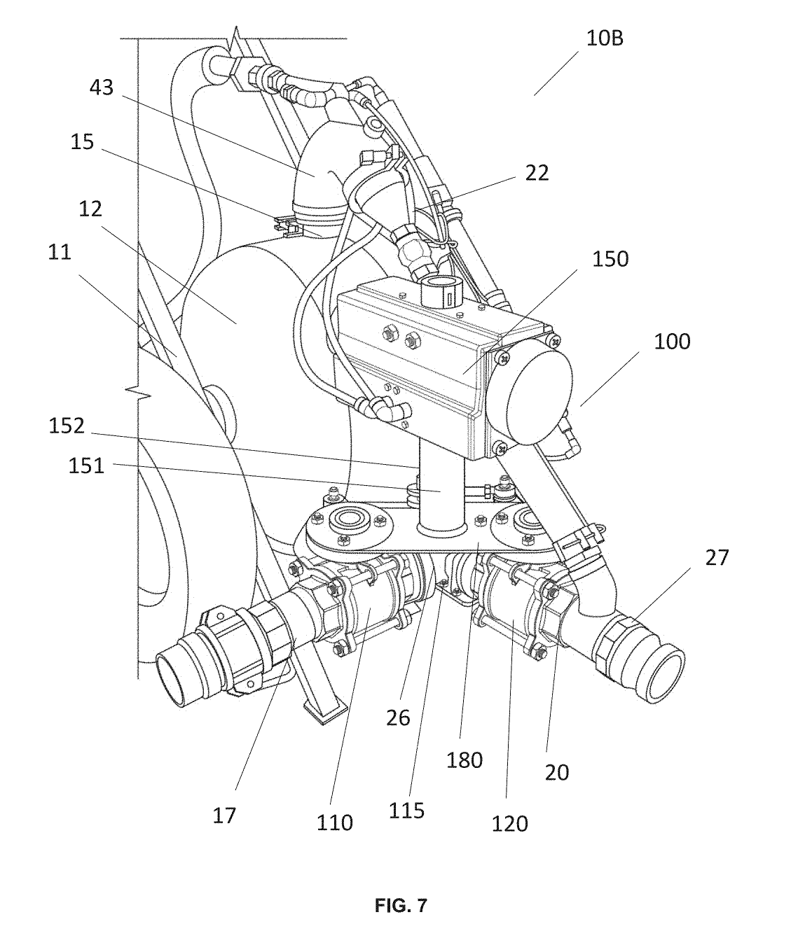

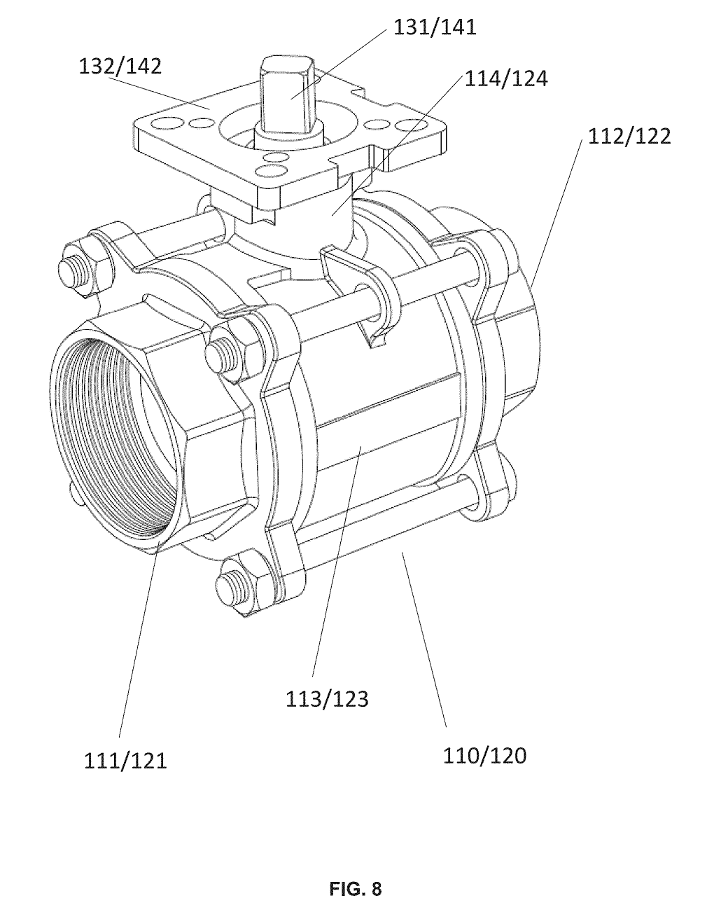

Rotatable valve apparatus 100 is shown in FIG. 7, incorporated into inlet assembly 17; T-connector 26; and outlet assembly 20 of pneumatic pump 10B. More particularly, rotatable valve apparatus 100 includes first valve body 110 incorporated into inlet assembly 17; second valve body 120 incorporated into outlet assembly 20; and intermediate body 115 incorporated into T-connector 26. Rotatable valve apparatus 100 further includes actuator 150.

As shown in detail in FIG. 8, first valve body 110 of rotatable valve apparatus 100 includes valve inlet end 111 and valve outlet end 112. Second valve body 120 similarly includes valve inlet end 121 and valve outlet end 122. Intermediate valve body 115 is located between first valve body 110 and second valve body 120, with intermediate body 115 connected to valve outlet end 112 of first valve body 100 and valve inlet end 121 of second valve body 120.

First valve body 110 of rotatable valve apparatus 100 includes rotation chamber 113 interposed between inlet end 111 and outlet end 112. Second valve body 120 similarly includes rotation chamber 123 interposed between inlet end 121 and outlet end 122. First and second rotatable valves 130 and 140, in the form of two-way ball valves, are respectively located within rotation chambers 113 and 123 of first valve body 110 and second valve body 120.

First and second rotatable valves 130 and 140 are engaged with valve shafts 131 and 141, respectively, which extend out from first valve body 110 and second valve body 120 through shaft channels 114 and 124.

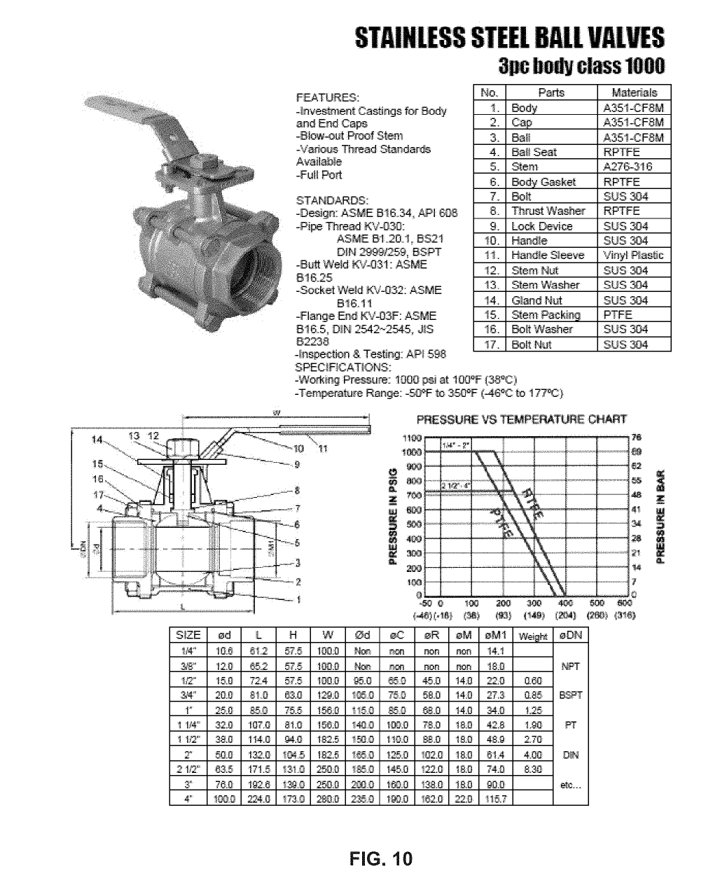

With reference to FIG. 8 and the above description, it will be appreciated that rotatable valve apparatus 100 comprises substantially standard ball valve components. For example, stainless steel WOG 1000 ball valves as manufactured by Unimech Group (Malaysia) under the Arita brand are typical for use according to rotatable apparatus 100. For illustrative purposes, manufacturer's information from Arita is set forth in FIG. 10.

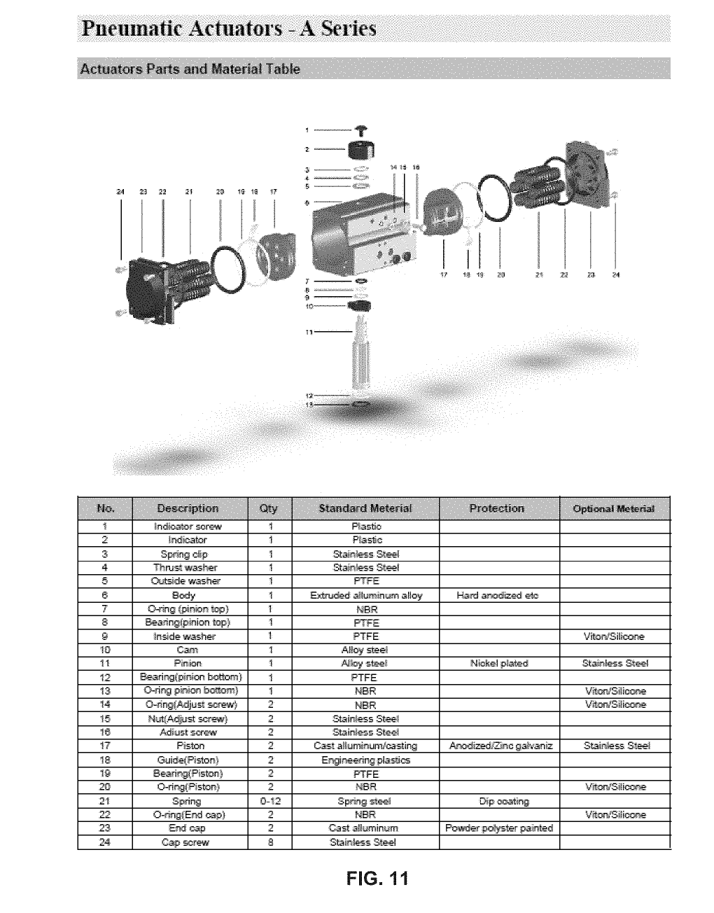

It will be further understood that valve actuator 150 of rotatable valve apparatus 100 is a pneumatic rotary actuator, as are known in the art. For example, actuator model A092 as manufactured by Wuxi Belef Pneumatic Actuators Co Ltd (China) is typical for use according to rotatable apparatus 100. Double actuating pneumatic rotary actuators are considered particularly desirable, although without limitation thereto. For illustrative purposes, manufacturers information from Wuxi Belef Pneumatic Actuators is set forth in FIG. 11.

While known ball valve and pneumatic rotary actuator components are suitable for use in rotatable valve apparatus 100, the arrangement and connection of ball valve and pneumatic rotary actuator components is specifically adapted for the purposes of the present invention, as described in detail as follows.

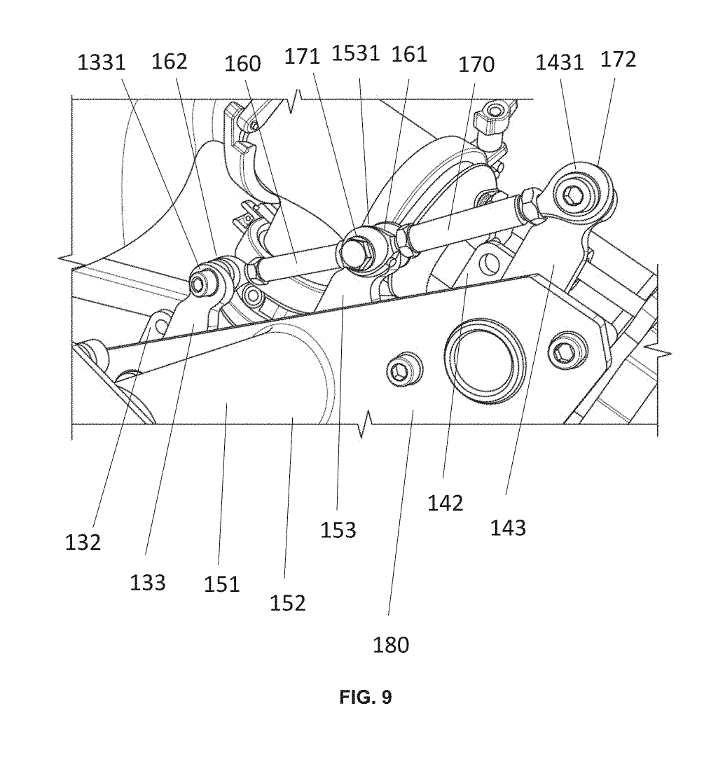

As set out in FIG. 9, valve actuator 150 is engaged with actuator shaft 151, located within shaft casing 152. Actuator shaft 151 of valve actuator 150 is engaged with actuator shaft lever 153.

Also set out in FIG. 9, valve shafts 131 and 141 of ball valves 130 and 140 are engaged with respective valve levers 133 and 143. First valve lever 133 and second valve lever 143 are located adjacent shaft channels 114 and 124, respectively, atop valve body connection pads 132 and 142.

Valve actuator 150 is connected to ball valve 130 via first arm 160; and to ball valve 140 via second arm 170. More particularly, first arm 160 extends from actuator shaft lever 153 to valve lever 133; and second arm 170 extends from actuator shaft lever 153 to valve lever 143.

The connection of first arm 160 to actuator shaft lever 153 and valve lever 133, and the connection of second arm 170 to actuator shaft lever 153 and valve lever 143, are rotatable connections. A bolt extends through aperture 1531 of actuator lever 153; aperture 161 at a first end of first arm 160; and aperture 171 at a first end of second arm 170, to rotatably connect actuator lever 153 with first arm 160 and second arm 170. A bolt extends through aperture 1331 of first valve lever 133; and aperture 162 at a second end of first arm 160, to rotatably connect first valve lever 133 with first arm 160. A bolt extends through aperture 1431 of second valve lever 143 and aperture 172 at a second end of second arm 170; to rotatably connect second valve lever with second arm 170.

Rotatable valve apparatus 100 also includes support plate 180, extending from shaft casing 152 to first valve body 110 and second valve body 120. Support plate 180 is in substantially fixed connection with shaft casing 152 and valve connection pads 132 and 142. As depicted, support plate 180 is welded to shaft casing 152 and bolted to valve connection pads 132 and 142. First valve lever 133 is positioned between valve connection pad 132 and support plate 180. Second valve lever 143 is positioned between valve connection pad 142 and support plate 180.

As best seen in FIG. 7, it will be appreciated that the relative orientation of the ball valve components of rotatable apparatus 100 are opposing. That is, outlet 112 of first valve body 110 is positioned towards outlet 122 of second valve body 120. The opposing orientation the ball valve components facilitates coordinated opening and closing of ball valves 130 and 140 in use, as described in further detail hereinbelow.

Typical use of pneumatic pump 10A/10B, swing valve apparatus 50, and rotatable valve apparatus 100 will now be described.

Pneumatic pump 10A/10B is typically used for pumping of non-homogenous flowable or semi-flowable compositions, such as drilling mud containing drill chips, in an industrial context. Typically, conduits, such as pipes or industrial hoses are connected to inlet assembly 17 and outlet assembly 20, such as by cam-lock. Broadly, the flowable composition is drawn in through a conduit connected to inlet assembly 17 during a suction phase, and pumped out through a conduit connected to outlet assembly 20 during a pressure phase.

In use, pneumatic pump 10A/10B is in the pressure phase when closure assembly 25 is closed, wherein air flow from constant-flow air jet 33 enters ventilation port 15, pressurising pressure vessel 12. When pneumatic pump apparatus 10A/10B is in the pressure phase, flowable substance is urged by pressure through transfer port 14 away from pressure vessel 12.

In use, pneumatic pump 10A/10B is in the suction phase when closure assembly 25 is open, wherein air flow within assembly 22 past closure 25 depressurises pressure vessel 12. When pneumatic pump apparatus 10A/10B is in the suction phase, flowable substance is urged by suction through transfer port 14 towards pressure vessel 12.

It will be understood that, in use, in the pressure phase, outlet 20 will allow flow of flowable substance being pumped by pneumatic pump 10A/10B away from pressure vessel 12 and, in the suction phase, inlet assembly 17 will allow flow of flowable substance being pumped by pneumatic pump 10A/10B towards pressure vessel 12.

As herein described, one or both of an inlet (such as inlet assembly 17) and an outlet (such as outlet assembly 20) of pneumatic pumps of the invention, may be fitted with a valve. Additionally, a control arrangement, such as that herein described with reference to FIG. 3, may be used to coordinate appropriate opening of valves of the inlet and/or outlet, during the respective pressure and suction phases.

Embodiment 10A of the pneumatic pump described herein comprises swing valve apparatus 50, incorporated into inlet assembly 17. In use, when the pressurisation phase is to commence, the slow-acting (dashpot), push-pull, positive-close actuator 30 positively closes swing valve apparatus 50, by action of pushrod 72 against back surface 70 of supporting body 62, wherein valve seat 55 closes swing chamber 52. On transition to the suction phase, positive-close actuator 30 slightly delays opening of the swing valve gate 17, allowing vacuum accumulation in the pressure vessel 12.

Embodiment 10B of the pneumatic pump described herein includes rotatable valve apparatus 100, incorporated into inlet assembly 17; T-connector 26; and outlet assembly 20. In use, when the pressurisation phase of pneumatic pump 10B is to commence, valve actuator 150 of rotatable valve apparatus 100 rotates actuator shaft 151 in a first direction, wherein actuator shaft lever 153 rotates in the first direction; ball valve 130 of inlet assembly 17 is rotated via first arm 160, first valve lever 133, and first valve shaft 131 into a closed configuration; and ball valve 140 of outlet assembly 20 is rotated via second arm 170, second valve lever 143, and second valve shaft 141 into an open position. When the suction phase of pneumatic pump 10B is to commence, valve actuator 150 of rotatable valve apparatus 100 rotates actuator shaft 151 in a second direction opposite the first direction, wherein ball valve 130 of inlet assembly 17 is rotated via first arm 160, first valve lever 133, and first valve shaft 131 into an open configuration, and ball valve 140 of outlet assembly 20 is rotated via second arm 170, second shaft lever 143, and second valve shaft 141 into a closed position.

To avoid doubt, it will be understood that rotation of actuator shaft lever 153 in the first or second direction results in rotation of first valve lever 133 and second valve lever 143 in substantially the same direction.

It will be further understood that rotation of first valve lever 133 and second valve lever 143 in the first or second direction results in opposite actions on first ball valve 130 and second ball valve 140. That is, rotation of first valve lever 133 in the first direction rotates first ball valve 130 towards the closed configuration; and rotation of second valve lever 143 in the first direction rotates second ball valve 140 towards the open configuration. Similarly, rotation of first valve lever 133 in the second direction rotates first ball valve 130 towards the open configuration; and rotation of second valve lever 143 in the second direction rotates second ball valve 140 towards the closed configuration.

In use, pneumatic pump apparatus 10A as described herein may be housed in a removable housing 74 having an air supply cut-out 75, an inlet cut-out and an outlet cut-out (not shown). The cover includes bolt holes 77 adapted to secure the cover 74 to the frame 11 at mount tags 80. It will be appreciated that pneumatic pump apparatus 10B may be housed in a similar removable housing, if desired.

Pneumatic pumps as herein described have been found to be highly desirable for pumping flowable compositions in industrial settings, wherein an ability to tolerate significant heat, chemical exposure, and/or physical force, both internally from material being pumped, and/or from the external environment, is required.

Embodiments incorporating a rotatable valve apparatus, such as rotatable valve apparatus 100, have been observed to offer surprising efficacy benefits in some circumstances. In particular, the use of rotatable valve apparatus 100 has been observed to offer significant advantages for pumping of highly heterogenous substances containing relatively large amounts of solid material. For these applications, pneumatic pumps incorporating a rotatable valve apparatus as described herein has offered substantial superiority in terms of continuous pumping at desirable flow rates. Rotatable valve apparatus 100 has been observed to be surprisingly superior for avoiding or limiting blockages and ineffective closure at inlet 17 and outlet 20.

By way of non-limiting example, one highly heterogenous flowable substance containing relatively large amounts of solid material may be drilling mud or drilling fluid, as is known in the art, comprising solids in the form of drill cuttings and/or rock fragments and the like.

The highly heterogenous substance may comprise at least about 5% solids by volume, inclusive of high gravity solids or the like and/or low gravity solids or the like. In embodiments, the highly heterogenous substance comprises at least 6%, 7%, 8%, 9%, 10%, 11%, 12%, 13%, 14%, 15%, 16%, 17%, 18%, 19%, 20%, 21%, 22%, 23%, 24%, or 25% solids by volume.

In this specification, terms such as “above” and “below”; “front” and “back”; “top” and “bottom”; “left” and “right”; “horizontal” and “vertical”, and the like, may be used herein for descriptive purposes. However, it will be understood that embodiments of the apparatus and system can potentially be arranged in various orientations, and that such relative terms are not limiting and may be interchangeable in appropriate circumstances.

In this specification, unless the context requires otherwise, the terms “connection”, “connected”, “connecting”, and the like, are not to be read as limited to direct connections, and may also include indirect connections. For example, unless the context requires otherwise, a stated first component “connected” to a stated second component may be connected via, through, or by, one or more unstated components.

It will be appreciated that the indefinite articles “a” and “an” are not to be read as singular indefinite articles or as otherwise excluding more than one or more than a single subject to which the indefinite article refers. For example, “an” arm includes one arm, one or more arms or a plurality of arms.

In this specification, the terms “comprises”, “comprising”, “includes”, “including”, and similar terms are intended to mean a non-exclusive inclusion, such that an apparatus, system, or method that comprises a list of elements does not include those elements solely, but may well include other elements not listed.

The above description of embodiments of the invention is provided for purposes of description to one of ordinary skill in the related art. It is not intended to be exhaustive or to limit the invention to a single disclosed embodiment. In some instances, well-known components and/or processes have not been described in detail, so as not to obscure the embodiments described herein.

As described, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

This application is a Continuation-in-Part application from U.S. patent application Ser. No. 15/319,540. This application also takes priority from Australian provisional patent application 2019901129. The full contents of U.S. Pat. No. 15/319,540 and AU 2019901129 are incorporated herein, by reference.

1. A rotatable valve apparatus for use in a pneumatic pump including:
first and second valve bodies having respective rotation chambers interposed between respective valve body inlets and valve body outlets;
first and second rotatable valves located within the respective rotation chambers; and
a valve actuator connected with the first and second rotatable valves, wherein the valve actuator is configurable between:
a first configuration wherein the first rotatable valve is open and flowable substance can pass between the first valve body inlet and the first valve body outlet, and the second rotatable valve is closed and flowable substance is constrained or prevented from passing between the second valve body inlet and the second valve body outlet; and
a second configuration wherein the second rotatable valve is open and flowable substance can pass between the second valve body inlet and the second valve body outlet, and the first rotatable valve is closed and flowable substance is constrained or prevented from passing between the first valve body inlet and the first valve body outlet.

2. The rotatable valve apparatus of claim 1, comprising an intermediate body located between the first valve body and the second valve body, wherein the intermediate body is engaged with the first valve body outlet and the second valve body inlet.

3. The rotatable valve apparatus of claim 1, wherein first and second rotatable valves are ball valves.

4. The rotatable valve apparatus of claim 1, wherein the valve actuator is a pneumatic actuator.

5. The rotatable valve apparatus of claim 1, wherein the valve actuator is a rotatable actuator.

6. The rotatable valve apparatus of claim 5, wherein the valve actuator comprises a rotatable shaft, wherein rotation of the rotatable shaft configures the actuator between the first configuration and the second configuration.

7. The rotatable valve apparatus of claim 6, wherein rotation of the rotatable shaft in a first direction towards the second configuration rotates the first rotatable valve from the open position towards the closed position and the second rotatable valve from closed position towards the open position; and rotation of the rotatable shaft in a second direction towards the first configuration rotates the first rotatable valve from the closed position towards the open position and the second rotatable valve from the open position towards the closed position.

8. The rotatable valve apparatus of claim 6, wherein the valve actuator comprises a first arm connecting the rotatable shaft of the valve actuator with the first rotatable valve; and a second arm connecting the rotatable shaft of the valve actuator with the second rotatable valve, wherein rotation of the rotatable shaft rotates the first rotatable valve via the first arm and the second rotatable valve via the second arm.

9. A pneumatic pump including:
a pressure vessel having a lower transfer port and an upper ventilation port;
a transfer assembly communicating with said transfer port and including an inlet for pumpable material, and a delivery outlet, said inlet and outlet incorporating a rotatable valve assembly facilitating selective flow therethrough;
a venturi assembly having a suction side communicating with said ventilation port and a closable exhaust vent selectively operable to cycle said ventilation port between a suction phase and a pressurized phase; and
a controller adapted to selectively close the exhaust vent,
wherein the rotatable valve assembly includes:
a first valve body forming at least part of the pneumatic pump inlet and a second valve body forming at least part of the pneumatic pump outlet, the first and second valve bodies having respective rotation chambers interposed between respective valve inlets and valve outlets;
first and second rotatable valves located within the respective rotation chambers; and
a valve actuator connected with the first and second rotatable valves, wherein the valve actuator is convertible between:
a first configuration wherein the first rotatable valve is open and flowable substance can pass between the first valve inlet and the first valve outlet, and the second rotatable valve is closed and flowable substance is constrained or prevented from passing between the second valve inlet and the second valve outlet; and
a second configuration wherein the second rotatable valve is open and flowable substance can pass between the second valve inlet and the second valve outlet, and the first rotatable valve is closed and flowable substance is constrained or prevented from passing between the first valve inlet and the first valve outlet.

10. The pneumatic pump of claim 9, wherein the controller adapted to selectively close the exhaust vent of the venturi of the pneumatic pump is further adapted to convert the valve actuator between the first configuration and the second configuration.

11. The pneumatic pump of claim 9, wherein the first and second rotatable valves of the valve assembly are ball valves.

12. The rotatable valve apparatus of claim 9, wherein the valve actuator of the valve assembly is a pneumatic actuator.

13. The rotatable valve apparatus of claim 9, wherein the valve actuator of the valve assembly is a rotatable actuator.

14. A method of pneumatically pumping a flowable substance including the step of passing the flowable substance through one or more conduits connected with a rotatable valve apparatus, the rotatable valve apparatus including:
first and second valve bodies having respective rotation chambers interposed between respective valve body inlets and valve body outlets;
first and second rotatable valves located within the respective rotation chambers; and
a valve actuator connected with the first and second rotatable valves, wherein the valve actuator is configurable between:
a first configuration wherein the first rotatable valve is open and flowable substance can pass between the first valve body inlet and the first valve body outlet, and the second rotatable valve is closed and flowable substance is constrained or prevented from passing between the second valve body inlet and the second valve body outlet; and
a second configuration wherein the second rotatable valve is open and flowable substance can pass between the second valve body inlet and the second valve body outlet, and the first rotatable valve is closed and flowable substance is constrained or prevented from passing between the first valve body inlet and the first valve body outlet,
to thereby pump the flowable substance.

15. The method of claim 14, wherein the flowable substance is a highly heterogenous flowable substance,
